(19) United States
(12) Patent Application Publication
(10) Pub. No.: US 2025/0150191 A1
(43) Pub. Date: May 8, 2025

(54) Detecting and Handling Timing Anomalies Using Optimized Time of Days (ToDs) in a Multiclock Domain PTP Architecture

(71) Applicant: Altera Corporation, San Jose, CA (US)

(72) Inventors: Krishna Kumar Simmadhari Ramadass, Bangalore (IN); Kishan Shenoi, Saratoga, CA (US)

(21) Appl. No.: 18/991,007

(22) Filed: Dec. 20, 2024

(51) Int. Cl. H04J 3/06

(52) U.S. Cl. CPC H04J 3/0667

(57) ABSTRACT

Integrated circuit devices, methods, and circuitry for a virtual time of day (ToD) engine to generate timestamps by using offsets associated with PTP clock domains. An integrated circuit device may include a number of ports configurable to communicate using timestamps corresponding to a number of Precision Time Protocol (PTP) clock domains. The integrated circuit device may also include a host data processing system to determine an offset for a first PTP clock domain of the plurality of PTP clock domains by calculating a difference between a first ToD provided by a clock source on the integrated circuit and one or more ToDs associated with the first PTP clock domain. The integrated circuit may further include a virtual ToD engine to generate a timestamp by adding the offset for the first PTP clock domain to a second ToD from the clock source and provide the timestamp to a port.

### BACKGROUND

The present disclosure relates generally to packet transmission in accordance with Precision Time Protocol (PTP). More particularly, the present disclosure relates to a virtual time of day (ToD) engine for facilitating packet timestamping.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Precision Time Protocol (PTP) is a protocol specifying synchronization between a TimeTransmitter (formerly referred to as master) and a TimeReceiver (formerly referred to as slaves or sometimes as subordinates). More specifically, PTP refers to ToD synchronization. PTP based communication is common in telecommunications systems and across other distributed networks. However, ToD is not a universal constant. Indeed, there are many different underlying clock domains (e.g., Global Positioning System (GPS), Galileo) operating at a constant offset.

Currently, in telecommunications and in other shared hardware environments, one network switch may accommodate multiple TimeTransmitters with independent source clocks. To enable PTP communication between a TimeTransmitter and downstream TimeReceivers, the network switch may include multiple Master ToD circuits for each TimeTransmitter. Supporting multiple TimeTransmitters in a multiclock PTP architecture may, therefore, be resource intensive. Current techniques for routing packets in a multiclock PTP architecture may be improved to increase resource efficiency.

Likewise, current techniques for routing PTP packets across a network switch benefit from security improvements. Indeed, PTP packets are non-encrypted and may, therefore, be prone to attacks (e.g., man in the middle attacks). For example, the TimeTransmitter and TimeReceiver may become unaligned if a man in the middle introduces incremental changes to packet timestamps resulting in clock wander. These small changes in packet timestamps may be undetectable until they grow large enough to cause an application to fail.

### BRIEF DESCRIPTION OF THE DRAWINGS

Various aspects of this disclosure may be better understood upon reading the following detailed description and upon reference to the drawings in which:

FIG. 1 is a diagram of a shared hardware environment, including TimeTransmitters and TimeReceivers, in accordance with aspects of the present disclosure;

FIG. 2 is a diagram of a network switch including a virtual ToD engine, in accordance with aspects of the present disclosure;

FIG. 3 is a diagram of a virtual ToD engine, in accordance with aspects of the present disclosure;

FIG. 4 is a flowchart depicting a method for adding a TimeTransmitter to a network switch with a virtual ToD engine, in accordance with aspects of the present disclosure;

FIG. 5 is a flowchart depicting a method for providing timestamps to downstream ports by using offsets maintained by a virtual ToD engine, in accordance with aspects of the present disclosure;

FIG. 6 is a diagram of a virtual ToD engine implementation for an open radio access network lower layer split C3 configuration (ORAN LLS-C3), in accordance with aspects of the present disclosure;

FIG. 7A is a diagram of a timestamp engine configurable to dynamically route packets between TimeTransmitters and downstream ports, in accordance with aspects of the present disclosure;

FIG. 7B is a diagram of a virtual ToD engine on a timestamp engine, in accordance with aspects of the present disclosure;

FIG. 8 is a diagram of a virtual ToD engine to enable the detection of time anomalies in an open radio access network lower layer split C2 configuration (ORAN LLS-C2), in accordance with aspects of the present disclosure;

FIG. 9A is a graph depicting ToDs for multiple TimeTransmitters, in accordance with aspects of the present disclosure;

FIG. 9B is a graph showing the plot of FIG. 9A depicting clock wander for one TimeTransmitter in accordance with aspects of the present disclosure;

FIG. 10 is a flowchart depicting a process of detecting timing anomalies by maintaining ToD offsets in a virtual ToD engine in an ORAN LLS-C2 configuration. in accordance with aspects of the present disclosure;

FIG. 11 is a diagram of a virtual ToD engine in an ORAN LLS C-3 configuration, in accordance with aspects of the present disclosure;

FIG. 12 is a flowchart depicting a process of detecting timing anomalies by maintaining ToD offsets in a virtual ToD engine in an ORAN LLS-C3 configuration, in accordance with aspects of the present disclosure; and

FIG. 13 is a block diagram of a data processing system that may incorporate the virtual ToD circuitry, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

The present disclosure relates generally to increasing efficiency and security in a multiclock PTP architecture. More specifically, the present disclosure relates to including a virtual ToD engine on a network switch to facilitate timestamping and time error analysis on PTP packets transmitted across the network switch. TimeTransmitters may use different source clocks (e.g., National Institute of Standards and Technology (NIST), Global Positioning System (GPS), Indian Regional Navigation Satellite System (INRSS)) to synchronize their networks. Inherent delays in network communications lead to slight offsets between these clocks. Nonetheless, it may be desirable to TimeTransmitters to have their own clocks distributed downstream. To allow TimeTransmitters to distribute their own clocks downstream, a virtual ToD engine is defined to maintain an offset between the TimeTransmitter's source clock and a local ToD maintained on the network switch. In an open radio access network lower layer split C2 configuration (ORAN LLS-C2), the local ToD may be provided by a Master ToD circuit, which is conditioned by a host data processing system to be aligned with the PTP clock domain of one TimeTransmitter communicating over the network switch. Likewise, in an ORAN LLS-C3 configuration, the local ToD may be provided by an embedded GPS clock on the network switch. Both embodiments are described in detail below.

Although the ToDs provided by the TimeTransmitters may differ (e.g., by nanoseconds), the underlying source clocks increment at constant pace. This is true because frequency is defined: one second is the same regardless of the source clock used. Because source clocks in modern telecommunications increment at a constant pace, the source clocks operate at a constant offset. The virtual ToD engine maintains ToD offset information to provide two primary advantages.

First, an integrated circuit may include one Master ToD circuit and supplement the ToD for many TimeTransmitters communicating across a network switch by adding or subtracting the TimeTransmitters' offsets against the ToD provided by a Master ToD circuit. For example, in an ORAN LLS C-2 configuration, rather than conditioning and maintaining Master ToD circuits for each TimeTransmitter accessing the network switch, only one Master ToD circuit may be defined and conditioned. Therefore, new TimeTransmitters operating with different source clocks may access the network switch for the first time without partial reconfiguration of the integrated circuit (e.g., a programmable logic device) on the network switch.

Second, the virtual ToD engine may act as a differential engine to determine whether any of the TimeTransmitters are associated with ToDs that fall outside of a threshold, which may indicate a clock timing error. This functionality is beneficial because a TimeReceiver cannot independently determine whether the ToD it receives from a TimeTransmitter is accurate. For example, in a boundary clock configuration, a timestamp of a PTP packet may change between the time it leaves an original TimeTransmitter (e.g., the original device transmitting a packet) and the time it reaches an intermediate routing device (e.g., a network switch acting first as a TimeReceiver and second as a TimeTransmitter). The intermediate routing device is unable to determine whether the timestamp it received is accurate or if it has been interfered with (e.g., by a man in the middle attack). By maintaining a virtual ToD engine, the integrated circuit on the network switch can evaluate the ToD offsets for each TimeTransmitter to determine if they fall outside of a threshold. When this threshold is breached, the TimeTransmitter (e.g., the customer/original TimeTransmitter) may be notified of a potential timing error.

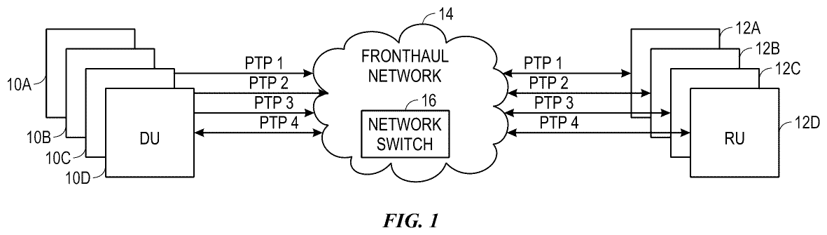

By way of introduction, FIG. 1 provides an example of a shared hardware environment with multiple PTP clock domains. In ORAN LLS-C2 and ORAN LLS-C3 configurations, O-RAN Distributed Units (O-DUs) 10A, 10B, 10C, 10D are connected over a network 14 (e.g., a fronthaul network) to one or more O-RAN Radio Units (O-RUs) 12A, 12B, 12C, 12D. The O-DUs 10A, 10B, 10C, 10D prepare data for transmission. Thus, the O-DUs 10A, 10B, 10C, 10D act as TimeTransmitters providing synchronization with downstream devices via PTP packets. Conversely, the O-RUs 12A, 12B, 12C, 12D are radio access nodes interfacing between customer devices (e.g., mobile phones) and the network 14. In PTP enabled architecture, the O-RUs 12A, 12B, 12C, 12D may act as TimeReceivers. In this example, the network 14 is a fronthaul network enabling the O-DUs 10A, 10B, 10C, 10D to transmit data to the O-RUs 12A, 12B, 12C, 12D. The network 14 includes any suitable number of network switches 16 to route the packets transmitted from an O-DU 10A, 10B, 10C, 10D to a desired O-RU 12A, 12B, 12C, 12D. The O-DUs and O-RUs may belong to different customers and, therefore, use different underlying clocks (e.g., different PTP clock domains).

By way of example, this could happen in a telecommunications environment when many customers (e.g., cellular service providers) transmit data over shared hardware like a cell tower. Thus, in the shared hardware environment, O-DUs 10A, 10B, 10C, 10D belonging to different customers may use the same network 14. The network switch 16 routes packets received from the O-DUs 10A, 10B, 10C, 10D to the available downstream ports, and resultingly to the O-RUs 12A, 12B, 12C, 12D. In this way, different customers can communicate with client devices across the downstream ports 44 in the shared hardware.

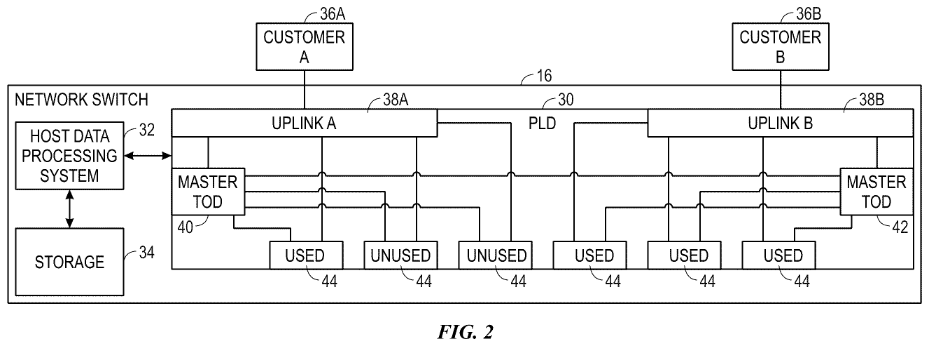

FIG. 2 is a diagram of a network switch 16. The network switch 16 may include a programmable logic device 30 to facilitate packet timestamping. The programmable logic device 30 may be any device that permits digital circuitry reconfiguration (e.g., a field programmable gate array (FPGA)). The network switch 16 may also include a host data processing system 32 and storage 34. Customers 36A, 36B transmit packets into the network switch 16 and may operate in different clock domains. For example, Customer A 36A may act as a TimeTransmitter providing PTP packets to synchronize to a first PTP clock domain, whereas Customer B 36B may act as a TimeTransmitter providing PTP packets to synchronize to a second PTP clock domain. Looking back to FIG. 1, Customer A 36A may control one or more of the O-DUs (e.g., O-DUs 10A, 10B). Similarly, Customer B 36B may control another O-DU (e.g., O-DU 10C). Each customer 36A, 36B may have a dedicated uplink 38A, 38B.

The programmable logic device 30 depicted in FIG. 2 also includes a Master ToD circuit 40 and a virtual ToD engine 42. The Master ToD circuit 40 and the virtual ToD engine 42 are communicatively connected. As Customer A 36A transmits PTP packets into the network switch 16 at the designated uplink 38A, the host data processing system 32 reads the timestamp of the PTP packets and conditions the Master ToD circuit 40. In this way, the Master ToD circuit is conditioned to the PTP clock domain of Customer A 36A. Conversely, as Customer B 36B transmits PTP packets into the network switch 16 at the designated uplink 38B, the host data processing system 32 reads the timestamp of the PTP packets and writes the correct timestamp to the virtual ToD engine 42. The host data processing system 32 may then use a PTP Servo to condition to the virtual ToD engine 42. For example, the host data processing system may calculate the offset between the ToD provided by the Master ToD circuit 40 and the ToD extracted from the PTP packets at the uplink 38B. The offset may be adjusted until a desired level of synchronization is reached. That is, the PTP servo running on the host data processing system 32 may attempt to steer or adjust the offset maintained by the virtual ToD engine 44. During this initial synchronization of the virtual ToD engine 42 to the PTP clock domain of Customer B 36, the PTP servo may incrementally adjust the offset maintained by the virtual ToD engine 42. The offsets that the PTP Servo uses to synchronize the virtual ToD engine 42 to the PTP clock domain of Customer B 36B are directly managed by the virtual ToD engine 42 to reflect the correct time of the PTP clock domain of Customer B 36B. The virtual ToD engine 42 maintains the offset to provide ToDs in response to timestamp read/write requests from connected network ports.

For example, the virtual ToD engine 42 may receive a timestamp write request from the host data processing system 32 running the PTP servo algorithm. When the virtual ToD engine 42 receives the timestamp write request, it reads the ToD from the Master ToD circuit 40. As described in the preceding paragraph, the ToD that the virtual ToD engine 42 reads from the Master ToD circuit 40 may be used to calculate the offset between the ToD received from the Master ToD circuit 40 and the ToD obtained from the PTP packets. After determining and storing the offset, the virtual ToD engine 42 may acknowledge the timestamp write request. After that, when a downstream port 44 associated with the virtual ToD engine 42 attempts to read the timestamp, the virtual ToD engine 42 reads the ToD from the Master ToD circuit 40 and adds the associated offset that was previously determined. Adding the offset to the ToD provided by the Master ToD circuit 40 produces a timestamp relative to the PTP clock domain of Customer B 36B. The timestamp is then provided to the downstream port 44 for every timestamp read request. With this, the virtual ToD provides an interface similar to the Master ToD circuit 40 to the PTP Servo running on the host processing system 32 but internally maintains the offsets. These offsets are used to then calculate the Customer B 36B specific timestamp without the need for other additional circuitry for maintaining synchronization among other TimeTransmitters (e.g., customers 36) in the multiclock architecture. Because the Master ToD circuit 40 and the virtual ToD engine 42 enable PTP synchronized communications, each downstream port 44 may be a PTP enabled Ethernet port.

FIG. 3 is a diagram of a virtual ToD engine 42. The virtual ToD engine 42 may receive inputs, including a source ToD 46 and one or more additional ToDs 48. The source ToD 46 may be provided by the Master ToD circuit (40 of FIG. 2) located on the network switch 16. The additional ToD 48 may be an input or output. For example, if the virtual ToD engine 42 is configured to maintain offsets for timestamp read/write requests for the downstream ports 44 (e.g., by providing an offset to be added to the Source ToD 46), then the additional ToD 48 may be an output to the host data processing system 32 and to other Ethernet ports 44 in another PTP domain. Conversely, if the virtual ToD engine 42 is acting as a differential engine, the additional ToD 48 may be an input ToD from a TimeTransmitter to be compared to the source ToD 46. This may be useful for determining if the offset between the source ToD 46 and additional Tod 48 is indicative of a timing error.

The status 50 and configuration 52 components of the virtual ToD engine 42 allow the virtual ToD engine 42 to engage in the previously described functionalities. The status component 50 is used to identify the current function of the virtual ToD engine 42 (e.g., an offset provider for generating ToDs or a differential engine). The configuration component 52 refers to the hardware and software logic enabling the virtual ToD engine 42 to be partially reconfigured to perform either functionality.

In either embodiment, the host data processing system 32 may calculate and evaluate ToD offsets between the source ToD 46 and the additional ToD 48. The virtual ToD engine 42 maintains a nanosecond register 54 and a fractional nanosecond register 56 that may store the difference (e.g., the offset) between the source ToD 46 and the additional ToD 48. In an ORAN LLS-C3 configuration, for example, if the source ToD 46 is provided by a GPS clock on the network switch and the additional ToD 48 is provided by a first Time Transmitter (e.g., via the host data processing system 32 reading timestamps from PTP packets transmitted into the network switch by the first TimeTransmitter), the offset stored by the nanosecond register 54 may be a number of nanoseconds representing the difference between the two ToDs. In the same example, the value stored by the fractional nanosecond register 56 may be fractions of a nanosecond (e.g., 0.1 nanoseconds, 0.01 nanoseconds) representative of the difference between the two ToDs.

Although the depicted virtual ToD engine 42 contains only one source ToD 46 and one additional ToD 48, it should be noted that, subject to the hardware constraints of the programmable logic device 30, the virtual ToD engine 42 may receive as inputs any number of additional ToDs 48. For example, if four TimeTransmitters are providing ToD packets to the network switch 16, the virtual ToD engine 42 may receive one source ToD 46 and three additional ToDs 48.

The virtual ToD engine 42 may also include Advanced extensible Interface (AXI) access 58 and a reset control 60. The AXI access 58 allows the virtual ToD engine 42 to receive inputs via AXI interfaces from one or more TimeTransmitters. The reset control 60 promotes partial reconfiguration when additional ToDs 48 are provided to the virtual ToD engine 42. This may occur, for example, when a new TimeTransmitter begins communicating over the network switch 16. When the new TimeTransmitter begins communicating over the network switch 16, the virtual ToD engine 42 may be partially reconfigured via the reset controls 60 to accept another additional ToD 48.

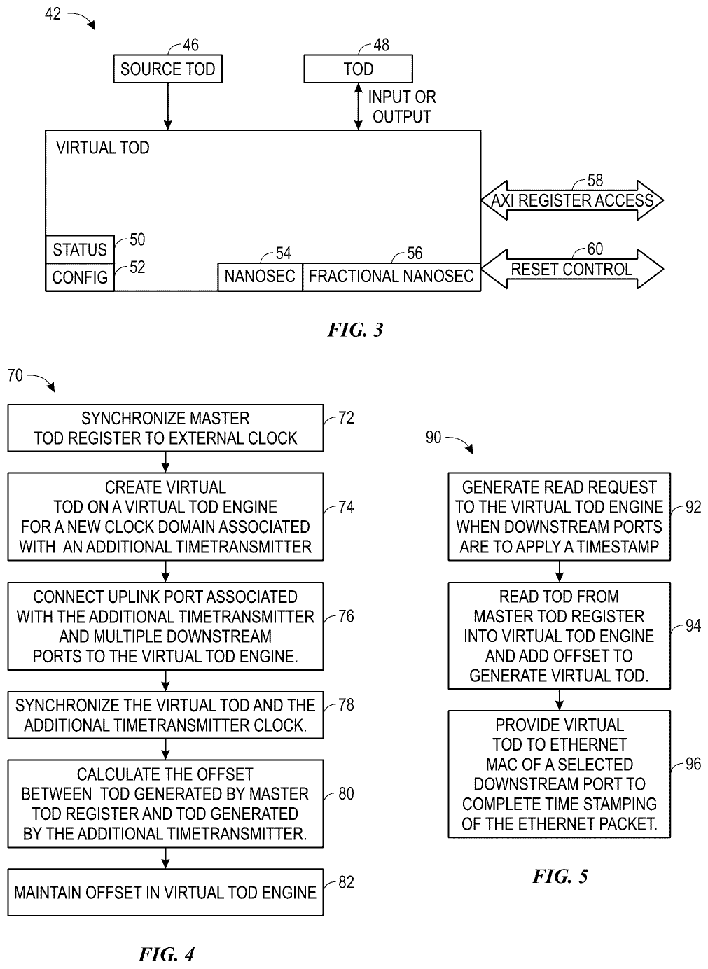

FIG. 4 is a flowchart depicting a method 70 for calculating and maintaining the offset of a new TimeTransmitter communicating across the network switch 16. Although the method 70 is described in a particular order, it should be understood that the method 70 may be performed in any suitable order and may exclude one or more of the blocks described herein.

At block 72, the programmable logic device 30 synchronizes the Master ToD circuit 40 to an external clock. Looking back at FIG. 2, the host data processing system 32 reads the timestamps (e.g., by way of a PTP stack running on the Uplink A port 38A) and conditions the Master ToD circuit 40 to the PTP clock domain of Customer A 36A.

Returning to FIG. 4, at block 74, the programmable logic device 30 creates a virtual ToD on the virtual ToD engine 42 for a PTP clock domain associated with the new TimeTransmitter communicating on the network switch 16. For example, the new TimeTransmitter may be Customer B 36B in FIG. 2.

At block 76, the programmable logic device 30 is virtually reconfigured to define and connect an uplink port 38 associated with the new TimeTransmitter to the virtual ToD engine 42 and one or more downstream ports 44. As depicted in FIG. 2, Customer B 36B is connected to Uplink B 38B. Uplink B 38B is connected to the Virtual ToD engine 42. Uplink B 38B and the virtual ToD engine 42 are connected to three of the downstream ports 44. Because AXI interfaces are communicative references (e.g., interfaces capable of communicating timing information or other data), any of the preceding connections may be made through AXI interfaces.

At block 78, the virtual ToD on the virtual ToD engine 42 is synchronized to the PTP clock domain (e.g., the source clock) of the additional TimeTransmitter. The host data processing system 32 may synchronize the virtual ToD by running a PTP servo on Uplink B port 38B to obtain the ToD from timestamps on the PTP packets provided by Customer B 36B. That is, the new TimeTransmitter provides one or more PTP packets to the network switch 16 via the uplink port 38 and the host data processing system 32 may use hard or soft logic to synchronize the virtual ToD to the new TimeTransmitter. Synchronization may be achieved based on the host data processing system 32 reading the timestamps from the virtual ToD. The virtual ToD engine 42 reads the ToD from the Master ToD circuit 40 and adds an initial offset to provide the virtual ToD. A PTP Servo may then steer the virtual ToD with offsets to achieve a desired level of synchronization. That is, the PTP Servo synchronizes the virtual ToD to the PTP clock domain of Customer B 36B by incrementally adding offsets to the ToD obtained by the host data processing system 32 from the PTP packets obtained at the uplink 38B. When the desired level of synchronization is achieved, the offset for Customer B 36B is achieved and maintained on the virtual ToD engine 42. For example, the host data processing system 32 may receive the initial ToD information from the PTP packets at the uplink 38B. The virtual ToD engine 42 reads the ToD from the Master ToD circuit 40, calculates the offset and programs the offset to its registers 54, 56. However, this offset may be steered (e.g., adjusted) by the PTP Servo as additional PTP packets are received. After the virtual ToD is sufficiently synchronized to the PTP clock domain of Customer B 36B, the offset that is maintained by the virtual ToD engine 42 may be used for the processing of additional timestamp read/write requests by the downstream ports 44 for synchronizing the TimeReceivers downstream.

At block 80, the virtual TOD engine 42 may calculate the offset between a ToD provided by the Master ToD circuit 40 and the virtual ToD provided by the additional TimeTransmitter (block 78). In other embodiments, such as in an ORAN LLS C-3 configuration, the virtual ToD engine 42 may receive the ToD from an embedded clock (e.g., a GPS clock on the network switch 16). The host data processing system 32 may calculates the offset using a PTP Servo. In some embodiments, the offset may be steered over time to reflect changes in the PTP clock domain of Customer B 36B. For example, as additional PTP packets are received, the PTP servo may create read/write requests to the virtual ToD engine 42 to steer the offset.

The offset is the difference between the two ToD values. The offset may be represented and stored in nanoseconds and/or fractional nanoseconds. Moreover, the offset may be positive or negative. For example, the offset may indicate that the ToD provided by the Master ToD circuit 40 is slightly ahead of the ToD obtained from new TimeTransmitter's source clock. Conversely, the ToD provided by the Master ToD circuit 40 may be slightly behind the ToD obtained from the new TimeTransmitter's source clock.

At block 82, the virtual ToD engine 42 writes the offset (block 80) into one of its registers. The offset may be stored in the nanoseconds register 54, fractional nanoseconds register 56, or both as depicted in FIG. 3. The offset is stored in the registers 54, 56 after processing by the virtual ToD engine 42 to mitigate delays associated with packet transmissions. For example, the virtual ToD engine 42 may adjust the offsets in response to wire delays, Master ToD read delays, or the like. The virtual ToD engine 42 may store offsets for many different TimeTransmitters. As discussed in the preceding paragraphs, additional TimeTransmitters may communicate over the network switch 16 and, therefore, across the programmable logic device 30. That is, the programmable logic device 30 may be partially reconfigured to define uplink ports for additional TimeTransmitters. When additional TimeTransmitters are provided access to the network switch 16, the method 70 may be repeated. Thus, when a second TimeTransmitter communicates across the network switch 16, the same steps may be repeated. The virtual ToD engine 42 may store the offset associated with the second TimeTransmitter's source clock as second ToD offset. In other embodiments, a second virtual ToD engine 42 may be defined to store the second offset.

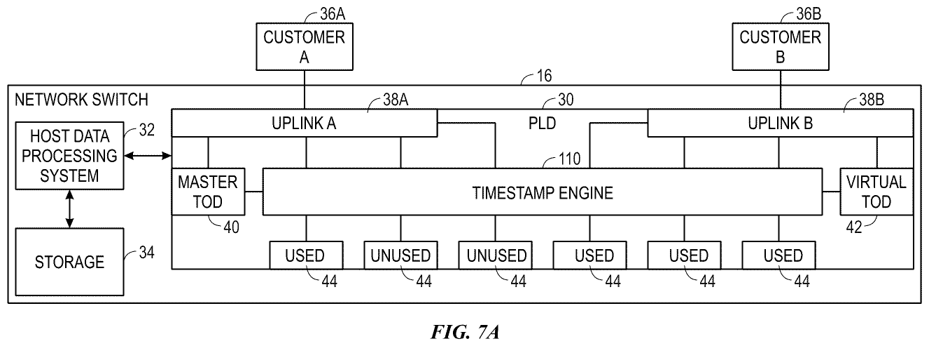

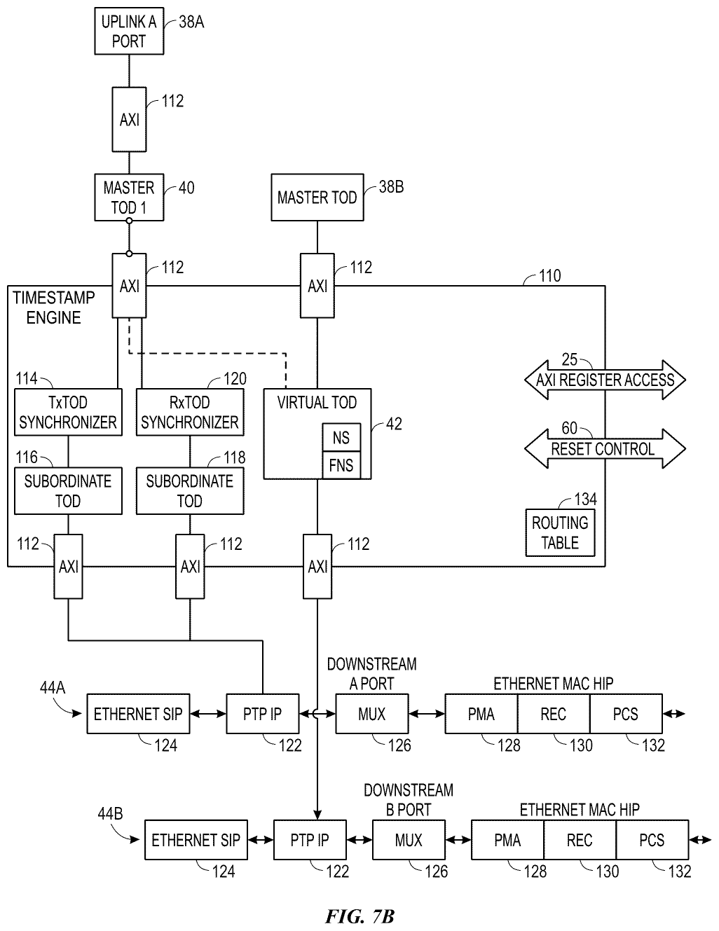

Maintaining the offsets for the additional TimeTransmitters communicating across the network switch 16 is useful for providing the downstream ports with ToDs in response to timestamp read/write requests. As discussed in detail with reference to FIG. 7B, the downstream ports 44 may generate timestamp read/write requests when they are transmitting or receiving a PTP packet. Because the offsets should be constant with respect to the source clock of each TimeTransmitter, the offset may be added to the local ToD to provide the downstream ports 44 with a ToD of the appropriate PTP clock domain for the TimeTransmitter communicating over said downstream port 44.

A method 90 for providing the downstream ports 44 with ToDs is depicted in FIG. 5. At block 92, a read/write request is generated requesting a time stamp. The read/write request may be generated by a downstream port 44. Because the downstream ports 44 may be PTP enabled Ethernet ports, they may use timestamps to maintain PTP synchronization.

Turning to block 94, the virtual TOD engine 42 reads a ToD provided by the Master ToD circuit 40 and adds the offset stored in its registers 54, 56. The offset added to the ToD provided by the Master ToD circuit 40 is the offset is associated with the TimeTransmitter communicatively connected to the downstream port 44. Adding the offset to the ToD provided by the Master ToD circuit 40 may be used to generate the timestamp that is aligned with the TimeTransmitter associated with the downstream port 44. For example, the downstream port 44 may be communicatively assigned to Customer B 36B. When the virtual ToD engine 42 returns the timestamp after adding the offset to the timestamp read from Master ToD circuit 40, the downstream port 44 can use it to timestamp the PTP messages which are routed to downstream devices in Customer B's 36B network.

At block 96, the timestamp that was generated at block 94 is provided to the downstream port 44. The timestamp may be provided to the Ethernet medium access control (MAC) of the downstream port 44. Providing the timestamp to the Ethernet MAC of the downstream port 44 enables the downstream port 44 to complete timestamping of the PTP packet subject to the timestamp read/write request (block 92). As described above, this method 90 of packet timestamping in accordance with PTP provides a benefit as it does not require the network switch 16 to maintain Master ToD 40 circuits for each additional TimeTransmitter communicating across the network switch 16.

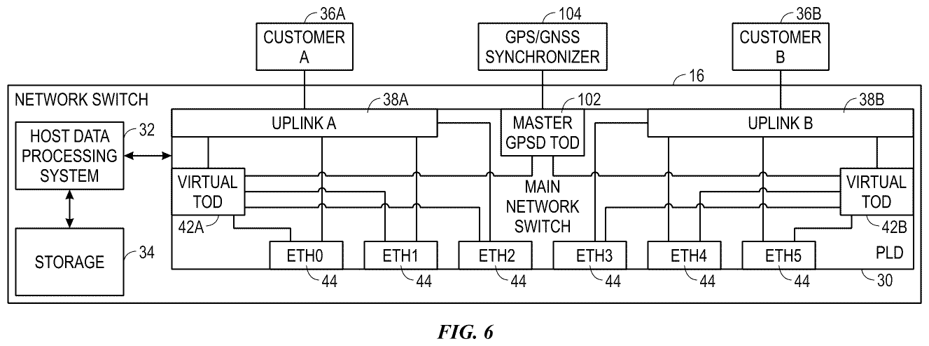

The benefits provided by the disclosed virtual ToD engine 42 are not limited to an ORAN LLS C-2 architecture. Indeed, FIG. 6 provides a diagram of a virtual ToD engine included in an ORAN LLS-C3 network switch 16. The different components of FIG. 6 correspond to those described with reference to FIG. 2 above. However, instead of a Master ToD circuit (40 in FIG. 2) the programmable logic device now includes two virtual ToD engines 42A, 42B. Each virtual ToD engine 42 is associated with a TimeTransmitter (e.g., the customers 36). For example, Customer A 36A communicates PTP packets to Uplink A 38A. The timestamps from the PTP packets transmitted from Customer A 36A and received at Uplink A 38A may be read by the host data processing system 32 to monitor and steer the virtual ToD 42A. The same is true for the PTP packets that Customer B 36B transmits to the network switch 16 at Uplink B 38B.

A Master Global Positioning System Daemon clock (Master GPSD) 102 acts as an embedded source clock on the programmable logic device 30 to provide the host data processing system 32 with ToDs to calculate the offsets for the respective customers 36. These offsets may be stored in the registers of the virtual ToD engine 42. For example, the offsets maintained by the virtual ToD engine 42 may be based on the ToDs provided by the Master GPSD 102. In this way, the offsets that are associated with each TimeTransmitter (e.g., Customer A 36A, Customer B 36B) may be calculated according to the method 70 described with respect to FIG. 4. The offset associated with Customer A 36A may be stored in the virtual ToD engine 42A. The offset associated with Customer B 36B may be stored in the virtual ToD engine 42B. These offsets may be used, according to the method 90 described with respect to FIG. 4, to provide ToDs to the downstream ports 44 in response to timestamp read/write requests. The Master GPSD 102 may be connected to a GPS/Global Navigation Satellite System (GNSS) synchronizer 104. The GPS/GNSS synchronizer 104 informs the Master GPSD 102. Therefore, the Master GPSD 102 may maintain an accurate ToD without manual clock resets.

Turning now to FIG. 7A, the disclosed technique for using a virtual ToD engine 42 to provide ToDs to the downstream ports 44 may also be incorporated into a programmable logic device 30 that includes a timestamp engine 110. A timestamp engine 110 may be used to dynamically associate the communicative interfaces (e.g., the AXI interfaces 112) between the different TimeTransmitters (e.g., Customer A 36A, Customer B 36B) and virtual ToD engines 42. The timestamp engine 110 may also dynamically associate the communicative interfaces between the virtual ToDs engines 42 and the downstream ports 44. The downstream ports 44 may be connected to different TimeReceivers. Accordingly, the downstream ports 44 need not be communicatively reserved for a certain TimeTransmitter with a specified PTP clock domain. As depicted, Customer 36A, 36B can communicate with any of the available downstream ports 44. In some embodiments, as depicted, the virtual ToD engine 42 may be maintained in the timestamp engine 110.

FIG. 7B provides a diagram of the timestamp engine 110. The Master ToD circuit 40 is connected to the timestamp engine 110 through any suitable interface, such as an AXI interface 112. The downstream ports 44 are also connected to the timestamp engine 110 by AXI interfaces 112. AXI register access 58 and reset control 60 may be useful for connecting additional uplink Ethernet ports 38 to the timestamp engine 110. Because the timestamp engine 110 promotes PTP synchronization, the downstream ports 44 may be PTP enabled Ethernet ports.

The downstream ports 44 may include various components to enable packet transmission and reception. For example, the downstream ports 44 may contain PTP extraction circuitry 122 (sometimes referred to as PTP IP or PTP intellectual property). The PTP extraction circuity 122 receives the ToD information from the timestamp engine 110 and completes packet timestamping. That is, when the downstream ports transmit or receive packets, the PTP extraction circuitry 122 may receive the ToD from the Master ToD circuit 40 or the virtual ToD engine 42 and complete packet timestamping.

The downstream ports 44 may also include soft logic circuitry 124. The soft logic circuitry 124 defines how the downstream ports 44 transmit and receive packets. That is, the timestamp engine 110 is predominantly designed to synchronize transmitted and received PTP packets to a ToD associated with the Master ToD circuitry 40 or virtual ToD engine 42. The soft logic circuitry 124 refers to the software implementation of Ethernet protocols. In other words, the soft logic circuitry 124 refers to the software protocol for transmitting and receiving PTP packets. The downstream ports 44 may also contain a multiplexer 126 for signal handling. The downstream ports 44 may use a physical medium attachment (PMA) 128 to transmit serialized parallel data and deserialize received data. The downstream ports 44 may include a forward error correction (FEC) component for error correcting in packet transmission. The downstream ports 44 may also contain a physical coding sublayer (PCS) 132 for packet mapping to the PMA interface 128.

Returning to the timestamp engine 110, the routing table 134 maintains the connections (e.g., routing paths) between the ToDs conditioned by the host data processing system 32 using the timestamps provided by the respective TimeTransmitters and the downstream ports 44. The routing table 134 allows the timestamp engine 110 to route timestamp read requests from a selected downstream port 44 to the Master ToD circuit 40 or virtual ToD engine 42 for the appropriate TimeTransmitter. For example, if one of the downstream ports 44B is communicatively connected to Customer B 36B and, therefore, Uplink B 36B, that downstream port 44B may generate a read request for a timestamp, and the timestamp engine 110 routes the read request to the appropriate virtual ToD engine 42. Likewise, if one of the downstream ports 44A is communicatively connected to Customer A 36A and, therefore, Uplink A 36B, that downstream port 44A may generate a read request for a timestamp, and the timestamp engine 110 routes the read request to the Master ToD circuit 40. In this way, when a timestamp read/write request is generated by any of the downstream ports 44A, 44B, the timestamp engine 110 routes the ToD from the respective Master ToD circuit 40 or the virtual ToD engine 42 associated with the communicatively connected TimeTransmitter. In other embodiments, it may be desirable to continuously stream ToDs to the PTP extraction circuitry 122 of the selected downstream port 44.

In some embodiments, synchronizers 114, 120 may be used to enable the streaming of ToDs from the Master ToD circuit 40 to the downstream ports 44. A transmitting ToD synchronizer (TxToD) 114 bridges the Master ToD circuity 40 to a transmitter module (TX module) of the selected downstream port 44. The TxToD synchronizer 114 is used because the programmable logic device 30 may be operating according to a different clock than the Master ToD circuitry 40. The TxToD synchronizer 114 synchronizes the ToD provided by the Master ToD circuit 40 to the clock domain of the programmable logic device 30 to determine a subordinate ToD 116. The subordinate ToD 116 is provided (e.g., via the connected AXI interface 62) to the PTP extraction circuitry 112 of the selected downstream port 44. This process enables a PTP packet to be transmitted to be timestamped. Likewise, when the downstream port 44 receives a PTP packet, it may timestamp the packet according to the designated Master ToD circuit 40 on the network switch 16. Thus, the timestamp engine 110 includes a receiving ToD synchronizer (RxToD) 120. The RxToD synchronizer 120 synchronizes the ToD provided by the Master ToD circuit 40 to the clock domain of the programmable logic device 30 to determine a subordinate ToD 118. This allows the PTP extraction circuity 122 of the downstream port 44 to complete timestamping of a received PTP packet.

Including the virtual ToD engine 42 on the timestamp engine 110 limits the application for additional TxToD and RxToD synchronizers 114, 120. This may promote resource efficiency as the programmable logic device 30 provides ToDs to downstream ports 44 for packet time stamping. For example, when a new TimeTransmitter begins transmitting packets to the network switch 16, additional TxToD and RxToD synchronizers 114, 120 may not be defined to accommodate the new TimeTransmitter.

Although FIG. 7A and FIG. 7B depict an ORAN LLS C-2 configuration, a timestamp engine 110 may also be included in an ORAN LLS C-3 configuration.

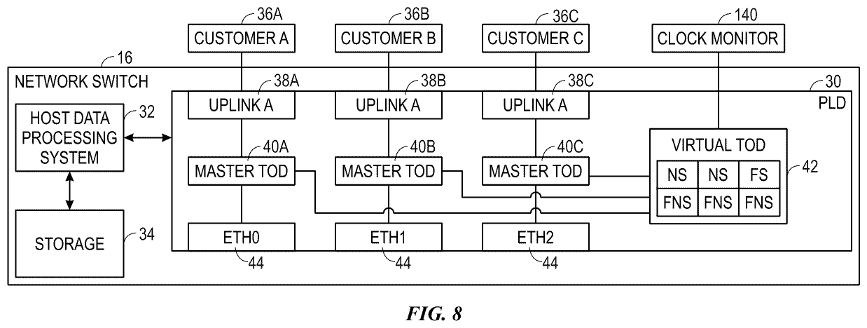

Turning now to the virtual ToD engine 42 functioning as a differential engine, FIG. 8 is a diagram of virtual ToD engine 42 for timing anomaly detection in an ORAN LLS C-2 configuration. As depicted in FIG. 2, customers 36A, 36B, 36C are communicating with downstream ports 44 across a network switch 16. The network switch 16 includes a programmable logic device 30 with dedicated uplinks 38A, 38B, 38C for the customers 36A, 36B, 36C. The uplinks 38A, 38B, 38C are communicatively connected (e.g., by AXI interfaces) to the Master ToD circuits 40A, 40B, 40C. The Master ToD circuits 40A, 40B, 40C are communicatively connected to the virtual ToD engine 42 using internal interfaces on the programmable logic device 30. The customers 36A, 36B, 36C act as TimeTransmitters providing PTP packets to the network switch 16.

In this embodiment, the virtual ToD engine 42 is connected to a clock monitor 140. The clock monitor 140 may be a hardware or software component that can perform mathematical/comparison functions, including generating a clock wander threshold, a clock jitter threshold, and evaluating the offsets associated with the TimeTransmitters (e.g., Customers 36A, 36B, 36C) against said thresholds.

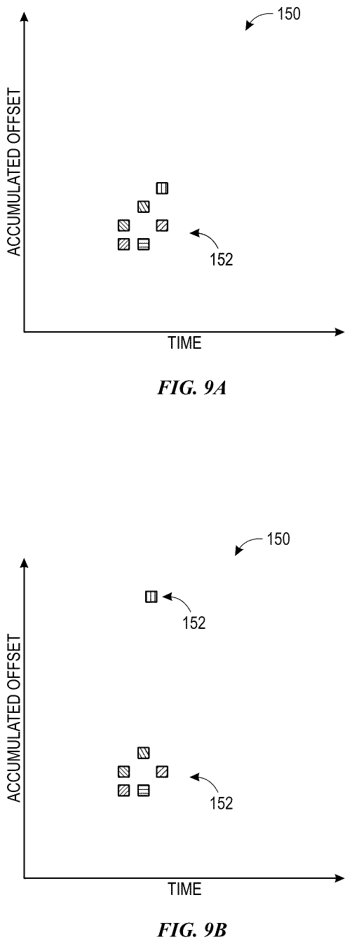

FIG. 9A and 9B provide a visual representation of clock wander to assist this explanation of timing anomaly detection. The graph 150 of FIG. 9A plots time against accumulated offset. ToDs 152 provided by many TimeTransmitters are tightly grouped. This grouping is indicative of a constant time error relative to the network switch 16. Turning to FIG. 9B, however, one ToD 154 associated with one Time Transmitter has strayed from the group of ToDs 152. This may be indicative of a timing error, such as unanticipated clock wander. Clock wander is a measurement of deviation from the actual ToD.

As explained throughout this disclosure, many TimeTransmitters use different source clocks. Because these clocks operate at a constant offset, the ToDs that they provide will not be exactly the same. Because the offsets are constant, however, the ToDs associated with each TimeTransmitter should be offset by a similar margin for each ToD packet that they transmit to the network switch 16. If the ToD packets transmitted by a first TimeTransmitter fall outside of a threshold range of the grouping of ToD packets (e.g., relative to the other TimeTransmitters communicating on the network switch 16), a ToD alert may be generated. The ToD alert may provide the TimeTransmitter with an indication that there is a likely error in packet transmission. For example, the programmable logic device may generate an alert signal (e.g., a tactile alert, a haptic alert, a graphical user interface display) to inform the associated TimeTransmitter of the indicated timing error.

Returning to FIG. 8, the clock monitor 140 may generate alerts to the TimeTransmitter experiencing the timing anomaly. The virtual ToD engine 42 maintains offsets (e.g., in nanoseconds and/or fractional nanoseconds) for each customer 36A, 36B, 36C transmitting packets across the network switch 16. The clock monitor 140 may use heuristic algorithms to identify patterns in the ToD offsets associated with each of the customers 36, and generate alerts if a ToD packet provided by a specific customer strays outside of a threshold. In some embodiments, the threshold may be predefined by a network service provider. In other embodiments, algorithms may be used to define a threshold. For example, machine learning algorithms may be used to dynamically evaluate ToDs and identify a threshold range of offset accumulation.

This offset evaluation may also assist service providers in detecting timing errors for their customers (e.g., TimeTransmitters). In situations where multiple network switches are connected across a general network, offset evaluation may be used to pinpoint the location of a timing error. For example, a downstream network switch detecting the offset wander may indicate that the devices between the downstream network switch and the preceding network switch are the likely cause of the timing error. A timing error of this sort may arise when there is a man in the middle attack. The alerts generated by the clock monitor 140 may notify the service providers and/or customer of the timing error and provide a locational range of where the error is likely occurring.

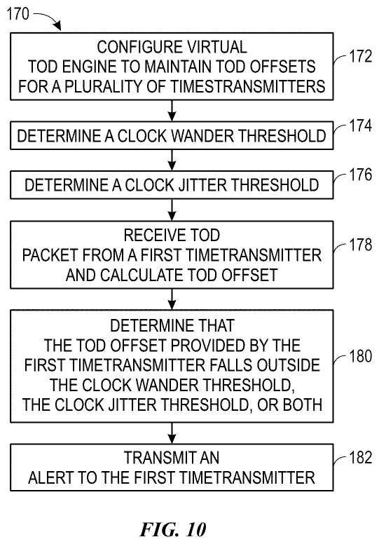

FIG. 10 provides a flowchart of a method 170 of identifying timing errors in an ORAN LLS C-2 configuration. At block 172, the virtual ToD engine 42 maintains ToD offsets for each TimeTransmitter transmitting packets to the network switch 16. As described above, the virtual ToD engine 42 maintains the offsets in nanosecond or fractional nanosecond registers (54 and 56 in FIG. 3). In some embodiments, the offset information for each TimeTransmitter may be updated (e.g., by the host data processing system 32 running a PTP Servo) as the network switch 16 receives additional PTP packets from the TimeTransmitters.

At block 174, the a clock wander threshold is generated. Clock wander refers to long term low frequency variations in a clock's phase. The clock wander threshold may be predetermined (e.g., by the service provider that owns the network switch 16). Alternatively, the clock wander threshold may be generated by applying a mathematical algorithm relative to the offset stored on the virtual ToD engine 42 for each TimeTransmitter. For example, a heuristic algorithm may be defined to identify a pattern or grouping range of ToD offsets to act as the clock wander threshold.

At block 176, a clock jitter threshold is generated. Clock jitter refers to short term high frequency fluctuations in a clock's phase. Detecting and resolving clock jitter may prevent undesirable channel to channel interference, improve channel performance, and reduce the likelihood of critical timing errors (e.g., errors causing application or transmission failure). The clock jitter threshold may be predetermined by the service provider. Alternatively, the clock jitter threshold may be generated by applying a mathematical algorithm relative to the offsets for each TimeTransmitter maintained on the virtual ToD engine 42. In other embodiments, machine learning algorithms may be used to calculate and shift (e.g., as more ToD packets are received by the network switch 16) the clock jitter threshold.

At block 178, a ToD packet from a first TimeTransmitter is received at the designated uplink 38. The timestamp may be received by the host data processing system 32 reading PTP packets from the first TimeTransmitter. The host data processing system 32 uses the ToD received from the timestamps of the PTP packets to condition (e.g., steer) the corresponding Master ToD circuit 40. The virtual ToD engine 42 may periodically read from all of the defined Master ToD circuits 40 to determine the corresponding ToD offsets associated with each of the Master ToD circuits 40. That is, in embodiments where the virtual ToD engine 42 acts as a differential engine, it may determine (e.g., calculate) the offsets associated with each TimeTransmitter. The ToD offsets for each of the Master ToD circuits 40 are then written into the registers of the virtual ToD engine 42. Thus, the offset associated with the first TimeTransmitter is stored in the registers of the virtual ToD engine 42.

At block 180, the ToD offset is evaluated against thresholds generated at blocks 174 and 176. The clock monitor 140 may be configurable to perform comparison functions between the

ToD offset associated with each TimeTransmitter and the clock wander and clock jitter thresholds. In embodiments, the host data processing system 32 may perform these comparison functions.

At block 182, an alert is generated to be transmitted to the TimeTransmitter experiencing the timing error. The clock monitor 140 may generate and transmit the alert to the TimeTransmitter. Additionally, the clock monitor 140 may transmit the alert to the service provider.

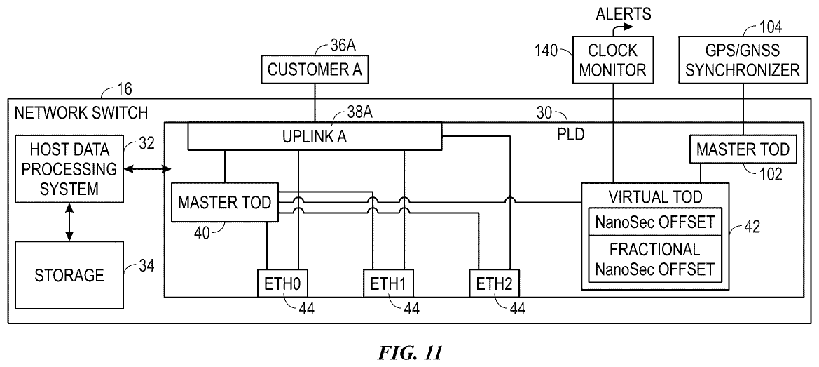

FIG. 11 provides a diagram of a virtual ToD engine 42 for use as a differential engine in an ORAN LLS C-3 configuration. The virtual ToD engine 42 receives the ToD from an embedded source clock 102 on the network switch 16. The source clock may be a Master ToD circuit 102 conditioned by a GPS/GNSS synchronizer 104. The host data processing system 32 periodically conditions and steers the Master ToD circuit 40 to match the TOD of the customer A 36A. The virtual ToD acting like a differential engine, periodically reads the Master ToD circuit 102 (40 in FIGS. 2 and 6) and compares them and calculates the offset between them. If the ToD offset falls outside of a threshold range of the ToD provided by the Master ToD circuit 102, the clock monitor 140 may generate an alert. The alert may be transmitted to Customer A 36A, the service provider, or both.

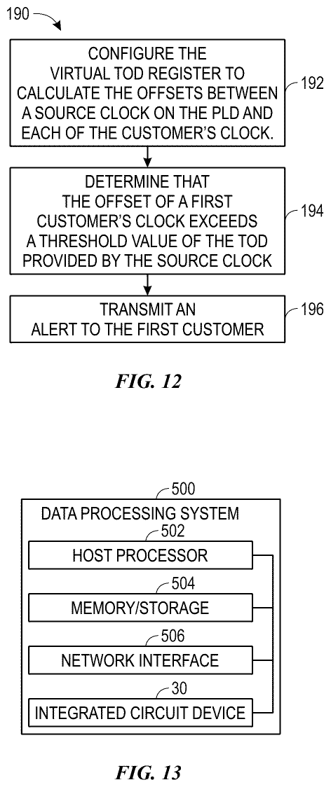

FIG. 12 is a flowchart depicting a method 190 of detecting timing anomalies in an ORAN LLS C-3 configuration. At block 192, the offsets between a source clock 102 on the programmable logic device 30 and each TimeTransmitter transmitting PTP packets across the network switch 16 are calculated. As described above, multiple offsets for different

TimeTransmitters may be maintained in the virtual ToD engine 42 by the nanosecond 54 and the fractional nanosecond 56 registers.

Moving to block 194, it is determined that the ToD offset of a first TimeTransmitter is outside of a threshold value of the ToD provided by the source clock 102. This determination may be made according to a comparison function performed by the clock monitor 140.

At block 196, an alert is generated and transmitted to the first TimeTransmitter, service provider, or both. The alert may be generated and transmitted according to the process described with respect to block 180 of FIG. 10.

The circuit discussed above may be implemented on the integrated circuit system 12, which may be a component included in a data processing system, such as a data processing system 500, shown in FIG. 13. The data processing system 500 may include the integrated circuit system 12 (e.g., a programmable logic device), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 13 may include the programmable logic device 30 with the virtual ToD engine 42. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit system 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the virtual ToD engine 42 described herein may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

### EXAMPLE EMBODIMENTS

### Example Embodiment 1

An integrated circuit device comprising:
a plurality of ports configurable to communicate using timestamps corresponding to a plurality of Precision Time Protocol (PTP) clock domains;
a host data processing system to perform operations, including:
   determining an offset for a first PTP clock domain of the plurality of PTP clock domains based on calculating a difference between a first ToD provided by a clock source on the integrated circuit and one or more ToDs read from one or more PTP packets of the first PTP clock domain; a virtual time of day (ToD) engine to perform operations, including:
   generating a timestamp by adding the offset for the first PTP clock domain to a second ToD provided by the clock source; and
   providing the timestamp to a port of the plurality of ports.

### Example Embodiment 2

The integrated circuit device of example embodiment 1, wherein the host data processing system initiates a PTP Servo to read the one or more ToDs from the one or more PTP packets of the first PTP clock domain and determine the offset between the first ToD provided by the clock source and the one or more ToDs read from the one or more PTP packets.

### Example Embodiment 3

The integrated circuit device of example embodiment 2, wherein the PTP Servo running on the host data processing system conditions the offset in response to additional ToDs read from additional PTP packets of the first PTP clock domain.

### Example Embodiment 4

The integrated circuit device of example embodiment 1, wherein the integrated circuit device is in an open radio access network lower layer split C2 (ORAN LLS C-2) configuration.

### Example Embodiment 5

The integrated circuit device of example embodiment 1, wherein the integrated circuit device is in an open radio access network lower layer split C3 (ORAN LLS C-3) configuration.

### Example Embodiment 6

The integrated circuit device of example embodiment 1, comprising:
a timestamp engine configurable to route the timestamp read/write requests from different ports of the plurality of ports to the virtual ToD engine or Master ToD circuits.

### Example Embodiment 7

The integrated circuit device of example embodiment 1, comprising:
a programmable logic device, wherein the virtual ToD engine is implemented in soft logic circuitry of the programmable logic device.

### Example Embodiment 8

The integrated circuit device of example embodiment 7, wherein the programmable logic device comprises a field programmable gate array (FPGA) device.

### Example Embodiment 9

The integrated circuit device of example embodiment 1, wherein:
the host data processing system performs operations, including:
   determining a second offset for a second PTP clock domain of the plurality of PTP clock domains based on calculating a difference between a third ToD provided by the clock source on the integrated circuit and a received ToD packet of the second PTP clock domain.

### Example Embodiment 10

The integrated circuit device of example embodiment 9, comprising:
a second virtual ToD engine to perform operations, including:
   generating a second timestamp based on adding the second offset for the PTP clock domain to a fourth ToD from the clock source; and
   providing the second timestamp to a second port of the plurality of ports.

### Example Embodiment 11

The integrated circuit device of example embodiment 1, wherein the virtual ToD engine is configurable to maintain multiple offsets based on maintaining a register of offsets associated with one or more PTP clock domains of the plurality of PTP clock domains.

### Example Embodiment 12

An integrated circuit device comprising:
a plurality of ports configurable to communicate using timestamps corresponding to a plurality of Precision Time Protocol (PTP) clock domains; and
a virtual time of day (ToD engine) to perform operations, including:
   determining an offset for a PTP clock domain of the plurality of PTP clock domains based on calculating a difference between a first ToD provided by a clock source on the integrated circuit and a received ToD packet of the PTP clock domain;
   determining that the offset surpasses a clock wander threshold, clock jitter threshold, or both; and
   transmitting an alert to a source of the received ToD packet.

### Example Embodiment 13

The integrated circuit of example embodiment 12, wherein the clock wander threshold and the clock jitter threshold are determined relative to one or more offsets stored on the virtual ToD engine for one or more PTP clock domains of the plurality of PTP clock domains.

### Example Embodiment 14

The integrated circuit device of example embodiment 12, wherein:
The clock source on the integrated circuit is synchronized to a Global Positioning System (GPS) or other global navigation satellite system (GNSS) synchronizer.

### Example Embodiment 15

The integrated circuit device of example embodiment 14, wherein the clock wander threshold is a first specified range, and the clock jitter threshold is a second specified range, wherein the specified ranges are a defined number of nanoseconds, fractional nanoseconds, or both.

### Example Embodiment 16

A method, comprising:
synchronizing a Master time of day (ToD) circuit to a first Precision Time Protocol (PTP) clock domain of a plurality of PTP clock domains;
receiving a first ToD associated with a second PTP clock domain of the plurality of PTP clock domains.
receiving a second ToD from the Master ToD circuit;
determining an offset between the first ToD and second ToD based on a difference between the first ToD and second ToD; and maintaining the offset in an offset register of a virtual ToD engine.

### Example Embodiment 17

The method of example embodiment 16, comprising:
receiving a read request from a first port of a plurality of ports, wherein the plurality of ports communicate using timestamps corresponding to the plurality of PTP clock domains;
receiving a third ToD from the Master ToD circuit and adding the offset associated with the first PTP clock domain of the plurality of PTP clock domains to generate a virtual ToD; and
providing the virtual ToD to the first port of the plurality of ports.

### Example Embodiment 18

The method of example embodiment 17, wherein the plurality of ports comprises a plurality of Ethernet ports.

### Example Embodiment 19

The method of example embodiment 18, wherein the offset register of the virtual ToD engines maintains one or more offsets in nanoseconds, fractional seconds, or both.

### Example Embodiment 20

A non-transitory, computer readable medium comprising instructions that, when executed by processing circuitry, cause the processing circuitry to perform operations comprising:
determining an offset for a Precision Time Protocol (PTP) clock domain of a plurality of PTP clock domains based on a difference between a first time of day (ToD) provided by a clock source on an integrated circuit and a received ToD packet of the PTP clock domain;
generating a ToD based on adding the offset for the PTP clock domain to a second ToD from the clock source; and
providing the ToD to a port of a plurality of ports, wherein the plurality of ports are configurable to communicate using timestamps corresponding to the plurality of PTP clock domains.

What is claimed is:

1. An integrated circuit device comprising:
a plurality of ports configurable to communicate using timestamps corresponding to a plurality of Precision Time Protocol (PTP) clock domains;
a host data processing system to perform operations, including:
determining an offset for a first PTP clock domain of the plurality of PTP clock domains based on calculating a difference between a first ToD provided by a clock source on the integrated circuit and one or more ToDs read from one or more PTP packets of the first PTP clock domain;
a virtual time of day (ToD) engine to perform operations, including:
generating a timestamp by adding the offset for the first PTP clock domain to a second ToD provided by the clock source; and
providing the timestamp to a port of the plurality of ports.

2. The integrated circuit device of claim 1, wherein the host data processing system initiates a PTP Servo to read the one or more ToDs from the one or more PTP packets of the first PTP clock domain and determine the offset between the first ToD provided by the clock source and the one or more ToDs read from the one or more PTP packets.

3. The integrated circuit device of claim 2, wherein the PTP Servo running on the host data processing system conditions the offset in response to additional ToDs read from additional PTP packets of the first PTP clock domain.

4. The integrated circuit device of claim 1, wherein the integrated circuit device is in an open radio access network lower layer split C2 (ORAN LLS C-2) configuration.

5. The integrated circuit device of claim 1, wherein the integrated circuit device is in an open radio access network lower layer split C3 (ORAN LLS C-3) configuration.

6. The integrated circuit device of claim 1, comprising:
a timestamp engine configurable to route the timestamp read/write requests from different ports of the plurality of ports to the virtual ToD engine or Master ToD circuits.

7. The integrated circuit device of claim 1, comprising:
a programmable logic device, wherein the virtual ToD engine is implemented in soft logic circuitry of the programmable logic device.

8. The integrated circuit device of claim 7, wherein the programmable logic device comprises a field programmable gate array (FPGA) device.

9. The integrated circuit device of claim 1, wherein:
the host data processing system performs operations, including:
determining a second offset for a second PTP clock domain of the plurality of PTP clock domains based on calculating a difference between a third ToD provided by the clock source on the integrated circuit and a received ToD packet of the second PTP clock domain.

10. The integrated circuit device of claim 9, comprising:
a second virtual ToD engine to perform operations, including:
generating a second timestamp based on adding the second offset for the PTP clock domain to a fourth ToD from the clock source; and
providing the second timestamp to a second port of the plurality of ports.

11. The integrated circuit device of claim 1, wherein the virtual ToD engine is configurable to maintain multiple offsets based on maintaining a register of offsets associated with one or more PTP clock domains of the plurality of PTP clock domains.

12. An integrated circuit device comprising:
a plurality of ports configurable to communicate using timestamps corresponding to a plurality of Precision Time Protocol (PTP) clock domains; and
a virtual time of day (ToD engine) to perform operations, including:
determining an offset for a PTP clock domain of the plurality of PTP clock domains based on calculating a difference between a first ToD provided by a clock source on the integrated circuit and a received ToD packet of the PTP clock domain;
determining that the offset surpasses a clock wander threshold, clock jitter threshold, or both; and
transmitting an alert to a source of the received ToD packet.

13. The integrated circuit of claim 12, wherein the clock wander threshold and the clock jitter threshold are determined relative to one or more offsets stored on the virtual ToD engine for one or more PTP clock domains of the plurality of PTP clock domains.

14. The integrated circuit device of claim 12, wherein:
The clock source on the integrated circuit is synchronized to a Global Positioning System (GPS) or other global navigation satellite system (GNSS) synchronizer.

15. The integrated circuit device of claim 14, wherein the clock wander threshold is a first specified range, and the clock jitter threshold is a second specified range, wherein the specified ranges are a defined number of nanoseconds, fractional nanoseconds, or both.

16. A method, comprising:
synchronizing a Master time of day (ToD) circuit to a first Precision Time Protocol (PTP) clock domain of a plurality of PTP clock domains;
receiving a first ToD associated with a second PTP clock domain of the plurality of PTP clock domains;
receiving a second ToD from the Master ToD circuit;
determining an offset between the first ToD and second ToD based on a difference between the first ToD and second ToD; and
maintaining the offset in an offset register of a virtual ToD engine.

17. The method of claim 16, comprising:
receiving a read request from a first port of a plurality of ports, wherein the plurality of ports communicate using timestamps corresponding to the plurality of PTP clock domains;
receiving a third ToD from the Master ToD circuit and adding the offset associated with the first PTP clock domain of the plurality of PTP clock domains to generate a virtual ToD; and
providing the virtual ToD to the first port of the plurality of ports.

18. The method of claim 17, wherein the plurality of ports comprises a plurality of Ethernet ports.

19. The method of claim 18, wherein the offset register of the virtual ToD engines maintains one or more offsets in nanoseconds, fractional seconds, or both.

20. A non-transitory, computer readable medium comprising instructions that, when executed by processing circuitry, cause the processing circuitry to perform operations comprising:
determining an offset for a Precision Time Protocol (PTP) clock domain of a plurality of PTP clock domains based on a difference between a first time of day (ToD) provided by a clock source on an integrated circuit and a received ToD packet of the PTP clock domain;
generating a ToD based on adding the offset for the PTP clock domain to a second ToD from the clock source; and
providing the ToD to a port of a plurality of ports, wherein the plurality of ports are configurable to communicate using timestamps corresponding to the plurality of PTP clock domains.
